(19) United States
(12) Patent Application Publication
(10) Pub. No.: US 2005/0030009 A1
(43) Pub. Date: Feb. 10, 2005

(54) Discrete absolute sensor and code

(76) Inventor: Daniel J. Moreno, El Paso, TX (US)

Correspondence Address: DELPHI TECHNOLOGIES, INC., M/C 480-410-202, PO BOX 5052, TROY, MI, 48007, US

(21) Appl. No.: 10/602,788

(22) Filed: Jun. 24, 2003

(51) Int. Cl. G01B 7/14

(52) U.S. Cl. 324/207.11; 341/1; 340/456; 340/686.1

(57) ABSTRACT

A transmission position encoder for a vehicle having a transmission, a transmission controller and a transmission shifter adapted to shift the transmission and reposition the transmission position encoder, the transmission position encoder comprising: a plurality of detectors for providing a plurality of signals to the controller, said plurality of signals corresponding to discrete positions of the transmission position encoder wherein the controller is adapted to determine if there is a failure in any one of the detectors as the transmission position encoder transitions from a single position to one other position.

### TECHNICAL FIELD

The present disclosure relates generally to a sensor or means for detecting gear modes and/or gear mode requests of a transmission of a vehicle.

### BACKGROUND

As an automatic transmission of a vehicles moves into and out of and back into specific gears or gear modes (e.g., park (P), reverse (R), neutral (N), drive (D or 4), and low drives (1, 2 and 3), four wheel drive (4WD) etc.) a means (e.g., valve) is positioned or re-positioned so that hydraulic pressure can be directed to appropriate transmission components. In addition, and if applicable, a mechanical device such as a parking rod or equivalent thereof is positioned for proper engagement when the vehicle is in park (P).

The valve and parking rod are linked to the transmission selector lever (located in the passenger compartment) via any known means. In some arrangements mode switches are designed to provide an electrical signal based on the gear or gear mode selected in order to provide the appropriate signal to a transmission controller, which comprises a means (e.g., microprocessor and algorithms) to actuate the devices (e.g. hydraulic valves) so that the requested shifting operation can be performed.

An example of a mode switch employed currently is a plurality of magnetic field sensors that are adapted to detect a pre-arranged pattern (corresponding to the shift status of the vehicle) and provide binary control signals that correspond to the pattern detected.

An example of such an arrangement is found in the following U.S. Pat. Nos., 5,307,013; 5,370,015; 6,339,325; and 6,353,399, the contents of which are incorporated herein by reference thereto.

As is typical in most encoders the number of bit changes or state changes is minimized using “gray code” wherein only one bit changes for every incremental change of position of the sensor or detector. This approach simplifies the required detection scheme and is desirable in detection schemes wherein there is continuous or continuous fast movement between the states. Thus, there is a lower likelihood of a transition being lost as only one bit is changing during each position or state change. However, and since there are multiple sensing elements used in the sensor assembly (e.g., necessary to provide the required state changes) and only one bit changes for each transition, in order to determine whether there is a failure in any one of the detection elements, for one of the outputs in the bit pattern, several cycles or transitions may be required before the failure is detected.

In order to provide a system capable of “knowing” whether a detection element has failed during each transition or during more critical functions related to state changes a redundant, backup or parallel system is employed.

In systems where contact sensor assemblies are employed a redundant assembly is relatively inexpensive. However, in non-contact assemblies wherein hall sensors, optical, led or otherwise are used the redundant circuits become more expensive.

### SUMMARY

A single encoder system having a plurality of detecting elements wherein the system is capable of detecting a failure in any one of the detection elements during particular state transitions.

A discrete position sensor and code sequence wherein a maximum number of state changes are provided for each increment of linear or angular position.

A transmission position encoder for a vehicle having a transmission, a transmission controller and a transmission shifter adapted to shift the transmission and reposition the transmission position encoder, the transmission position encoder comprising: a plurality of detectors for providing a plurality of signals to the controller, said plurality of signals corresponding to discrete positions of the transmission position encoder wherein the controller is adapted to determine if there is a failure in any one of the detectors as the transmission position encoder transitions from a single position to one other position.

A transmission position encoder for a vehicle having a transmission, a transmission controller and a transmission shifter adapted to shift the transmission and reposition the transmission position encoder, the transmission position encoder comprising: a means for providing a plurality of signals to the controller, the plurality of signals corresponding to discrete positions of the transmission position encoder wherein the controller is adapted to determine if there is a failure in the means as the transmission position encoder transitions from a single position to one other position.

A bit map for a transmission position encoder having a plurality of sensors for a vehicle having a transmission, a transmission controller and a transmission shifter adapted to shift the transmission from any one of the following states of the transmission: park, reverse, neutral, drive, and any one of a plurality of gear positions comprising drive, the transmission shifter is also adapted to reposition the transmission position encoder, the bit map comprising:
a plurality of states corresponding to the position of the plurality of sensors of the transmission position encoder, wherein each of the plurality of states changes as the transmission is shifted from park to reverse and wherein at least two of the plurality of states are changed in any other shifting sequence of the transmission.

### BRIEF DESCRIPTION OF THE DRAWINGS

The present disclosure will now be described, by way of example, with reference to the accompanying drawings, in which:

FIG. 1 is a schematic illustration of a vehicle drive train.

### DESCRIPTION OF THE EMBODIMENTS

Disclosed herein is a digital code sequence for a linear or angular position sensor adapted to be used with or as a transmission mode sensor wherein the number of state changes for each increment in the linear or angular position sensor is maximized. The maximization of state changes allows a controller adapted to be in communication with the sensor to quickly determine (e.g., in a short number of increments of the linear or angular position) whether a failure has occurred within the sensing system.

Moreover, this sequence is also adapted to require all states to change in particular operations (e.g., park to reverse and neutral to drive and vice versa).

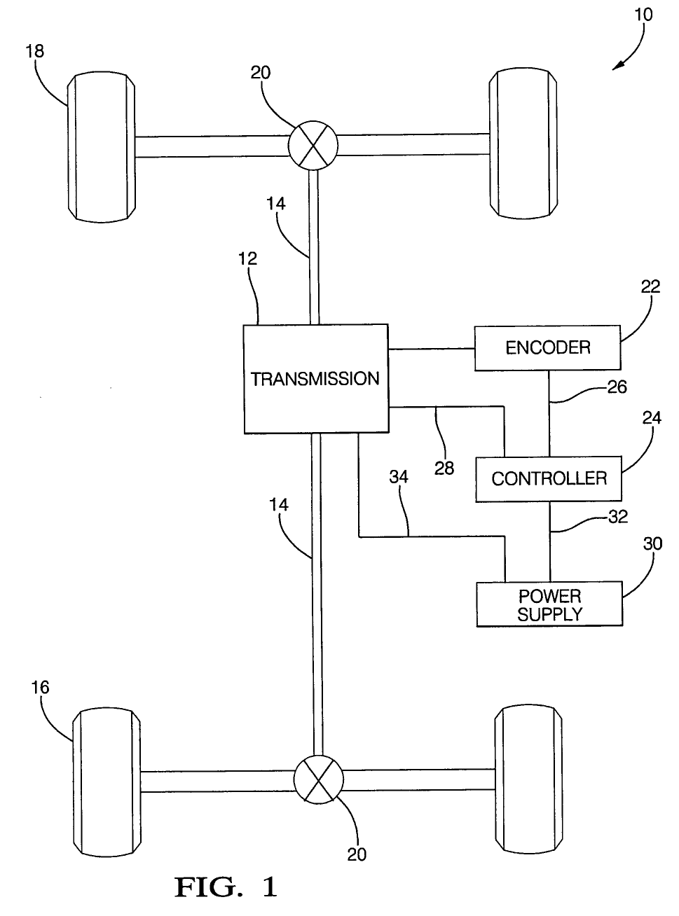

Referring now to FIG. 1, a vehicle drive train 10 is illustrated schematically. Drive train 10 is for illustration purposes only and is not intended to limit the present disclosure. As illustrated drive train 10 includes a transmission 12 which is adapted to provide a driving force via a torque output shaft 14 to either a front 16 or rear wheel 18 or both (e.g., four wheel drive) via a differential 20 in accordance with any known techniques and/or technologies.

A gear position device or an encoder or encoder assembly 22 is positioned to provide signals which correspond to the current position of the transmission or alternatively a shift lever or stick shift adapted for manipulation by a driver of the vehicle wherein movement of the shift lever translates to a shifting command that will ultimately be received by the transmission. In accordance with the present disclosure gear position device, encoder or encoder assembly 22 is a linear or angular position sensor assembly adapted to provide output signals related to the linear or angular movement of the assembly, which is manipulated by movement of the shift the lever or an operator's request to engage the transmission of the vehicle.

In accordance with the present disclosure gear position device or encoder or encoder assembly 22 is positionable anywhere within the vehicle including within the transmission itself as long as there is a means (mechanical or otherwise) for moving a plurality of sensors with respect to another item having a medium capable of being sensed by the sensors moving with respect to the medium or vice versa.

For example, a plurality of Hall effect sensors positioned to be moved with respect to a corresponding number of magnetic strips or a plurality of magnetic strips adapted to be moved with respect to the Hall effect sensors or an array of stationary magnetic sense elements position over magnets where an encoded ferrous plate moves between the elements to shield or open the magnetic flux to the sense element, wherein the sensors will in accordance with known technologies produce a high or low signal corresponding to the presence or lack of presence of the magnetic field generated by the magnetic strips. Of course, other means for producing signals to be sensed by a sensing array in combination with the truth tables disclosed herein are contemplated to be within the scope of the present disclosure. One such example is a parallel array of light sources and photodetectors with moving plate shields that allows the light to reach the photodetector wherein the shield will allow the light sources to reach the photodetectors in accordance with the truth tables disclosed herein. It is noted that the above are examples of devices contemplated for use with the present disclosure and the invention disclosed herein is not intended to be limited by the same. For example, other equivalent means are contemplated for producing multiple signals to be sensed by a detecting means in accordance with movement of a transmission shifter as outlined in the truth tables of the present disclosure. Thus, any other known or equivalent means for generating a sensed output is considered to be within the scope of the present invention.

A controller 24 is adapted to communicate with a gear position device or an encoder or encoder assembly 22 via signal line or bus 26 in order to receive the outputs of the gear position device. Controller 24 comprises a microprocessor adapted to operate under stored program control or an algorithm. Controller 24 is also adapted to communicate with the transmission via signal line or bus 28 and a power supply 30 via a signal line or bus 32. Thus, the controller and the transmission are each coupled to a source of energy and the encoder receives power through the controller by bus 26. If necessary, power supply 30 is adapted to communicate or provide power to the transmission via signal line or bus 34.

As the encoder is manipulated by for example, movement of the shift lever signals are generated by the encoder, which are received by the controller that in response to the signals received performs the necessary tasks (e.g., causing the transmission to move from one gear to another or manipulate a valve) to comply with the request received by the encoder. For example, if the encoder is manipulated by the shift lever, which corresponds to a request to cause the transmission to move from one state to another (e.g., park to reverse), a discrete signal corresponding to this request is sent to the controller. The controller interprets the request and sends a signal via line 28 to manipulate a gear or hydraulic valve or any other equipment device necessary to cause the transmission to operate in accordance with the request.

As discussed above, it is desirable to provide a system wherein the controller will be able to know whether one of the detection elements of the encoder is not operating properly thus, the controller can in accordance with the programming of an algorithm determine what protocol to follow in the event of a detection sensor failure. This is achieved by for example, comparing the bit pattern received from the encoder to a truth table stored in the memory of the microprocessor. Thus, the controller via bus lines 26 and 28 will be able to know what states the transmission is in (via line 28 ) and what state the encoder indicates that the transmission should be in. Therefore, if there is a discrepancy between the two the system will be able to employ an algorithm corresponding to such a situation. As discussed above the usage of “gray code” may require additional state transitions to determine whether there is a failure in one of the detectors.

In addition, the controller is adapted to track the state changes from each position to the next forklift determination of a failure of a sensor.

Thus, and in accordance with an exemplary embodiment, the present disclosure relates to a method for determining whether a detector of a transmission mode sensor is not operating by using a single encoder with a bitmap that maximizes the changes between each transition.

Referring now to the state table or truth table provided below an exemplary embodiment of the present disclosure is illustrated.

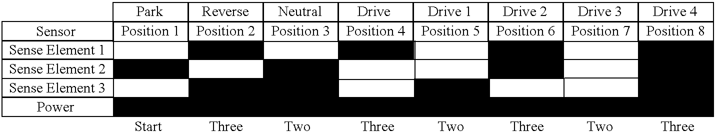

In accordance with an exemplary embodiment of the present disclosure gear position device, encoder or encoder assembly 22 has a bit map as illustrated above. The bit map is orientated such that each position has a unique binary code and a unique number or maximum number of state changes occurs in the three Hall sensors as the transmission is shifted.

Although the above table discusses three Hall sensors it is contemplated that the encoder or encoder assembly having the above bit map may be employed with different technologies, e.g. optical, magnetic, direct contact, or equivalent thereof wherein the above state changes are observed by the detection device.

In accordance with an exemplary embodiment the sensor assembly powers up in a mixed state (e.g., some of the outputs of the sensors in park are high while others are low). Thus, the start position has a mixture of On and Off states. As the gear shifter is moved from park to the next state (reverse) all three of the outputs must change. Thus, the system will be able to determine during the transition from a first state to a second state whether there is a failure in one of the sensing elements as each of these three states must change. In addition, the states are changing from a mixed power up mode such that a short circuit does not require several state changes to be detected. Accordingly, a short circuit condition will be detected immediately.

Accordingly, and in an exemplary embodiment three sensors and three sensor patterns are optimised for accurate and reliable detection of discrete positions as well as failures of the sensors.

In addition, and in accordance with an exemplary embodiment, the algorithm of controller 24 is adapted to require the mixed output corresponding to the park position to be received before the algorithm will allow a command for engagement of a gear other than park.

As illustrated above, in order to transition from park to reverse all outputs must change. This is also true for transitions between neutral and drive as well as (drive1-drive2) and (drive3-drive4). In all other positional changes, there is a minimum of two state changes. In addition, all (1) states or On states will change in the first transition. Thus, the controller will be able to determine very quickly from power up to the first transition whether one of the sensing elements is defective or inoperative.

In addition, and in an exemplary embodiment, the controller will track the sequence of changes between each position and correlate to the bit map for “state of health” monitoring of the absolute position sensor. The controller will have a look up table corresponding to the above table in order to determine whether the system is functioning properly. The controller will track the state changes and if an error is detected the controller will have additional software or an algorithm to execute a command such as vehicle shut down, prohibit further shifting of the transmission or run a diagnostic. Of course, the operations of the controller are numerous and may vary.

The above map differs from existing techniques by maximizing the changes between consecutive positions and it gives alternating states for the power up position. This technique increases the reliability of a slow moving discrete position sensor that powers up in the same state, such as transmission mode sensors by maximizing the probability of detecting a defect or malfunction in the sensing system. By powering up with alternating high and low states any failure modes that would cause all states to provide the same output will be eliminated. By changing every state in the first position the switches are exercised to ensure proper operation. By tracking the order in which the positions change, any malfunction in individual switches will be detected. This approach increases the reliability of a transmission mode sensor and may reduce the system costs by eliminating the need for redundant assemblies or extra bits to increase the sensor reliability.

The various bit values for each of the four channels get dynamically modified in accordance with sensed position as the transmission or shifter moves from one main-stop to another. Each main-stop position has a unique code comprised of the bit values for each channel of information.

Numerous variations of the present disclosure are contemplated for example, encoders of different technologies, e.g. optical, magnetic, direct contact, non-contact, LED or equivalents thereof. The encoder often receives a power supply from an external source but it does not in some designs. The number of channels (output binary lines) of the encoder assembly can also be different. Finally, the controller circuitry to process the digital information of the encoder may be designed in different ways. There may be differences in designs and implementation but, in principle, the end result is the same, that is, the information associated with transmission's position is transmitted to the controller via some binary signals.

As an alternative embodiment a fourth sensing element is added, the truth table for this embodiment is reproduced below. Here, all bits change at a transition position between each lever or gear position. Thus, a Transmission Range Sensor is provided wherein failure of a sensor can be determined through a signal transition from one state to another. Also, and as illustrated below there is also a transition state having a unique binary code corresponding to positions between each gear. Therefore, there is a bit change before and after each gear as well as the gear position itself.

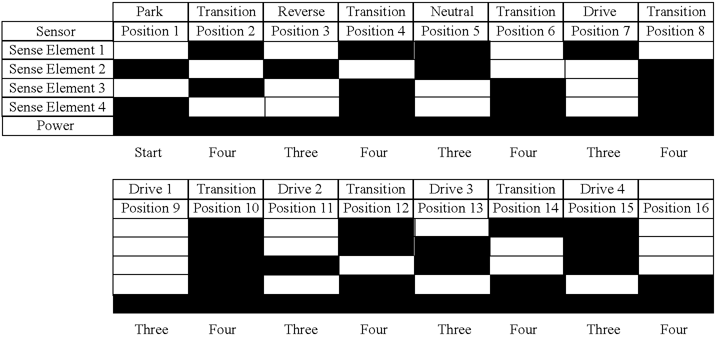

In any embodiment of the present disclosure, the system is powered up in a mixed state and the controller will track the sequence of changes between each position correlated to the bit map for “state of health” monitoring of the absolute position sensor.

Also, as the number of sensing elements increases the number of positions or transitions tracked increases for example, 3 sense elements=8 positions; 4 sense elements=16 transitions, thus;

The number of transitions=2^{(number of sense elements)}.

It is also noted that the present disclosure is not intended to be limited to 3 or 4 sensing elements as it is contemplated that more or less sensing elements may be used in accordance with the present disclosure.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the present disclosure not be limited to the particular embodiment disclosed as the best mode contemplated for carrying out this invention, but that the invention will include all embodiments falling within the scope of the appended claims. Furthermore, no element, component, or method step in the present disclosure is intended to be dedicated to the public regardless of whether the element, component, or method step is explicitly recited in the claims.

1. A transmission position encoder for a vehicle having a transmission, a transmission controller and a transmission shifter adapted to shift the transmission and reposition the transmission position encoder, the transmission position encoder comprising:
a means for providing a plurality of signals to the transmission controller corresponding to positions of the transmission position encoder, the transmission position encoder being manipulated into discrete positions by the transmission shifter wherein the transmission controller is adapted to determine if there is a failure in said means as the transmission position encoder transitions from a single position to one other position.

2. The transmission position encoder as in claim 1, wherein said means comprises a bit pattern corresponding to three detectors each having a unique bit pattern corresponding to the positions of the transmission position encoder.

3. The transmission position encoder as in claim 1, wherein said means comprises a bit pattern corresponding to four detectors each having a unique bit pattern corresponding to the positions of the transmission position encoder.

4. The transmission position encoder as in claim 3, wherein said means comprises a bit pattern corresponding to four detectors and a unique binary code is provided for each gear of the transmission and a transition position before and after each gear position.

5. The transmission position encoder as in claim 2, wherein each state of said bit pattern changes when the transmission is shifted from park to reverse.

6. The transmission position encoder as in claim 2, wherein each state of said bit pattern changes when the transmission is shifted from neutral to drive.

7. The transmission position encoder as in claim 5, wherein said bit pattern is in a mixed state corresponding to the transmission being in park.

8. The transmission position encoder as in claim 5, wherein the bit pattern of at least two of the three detectors changes with any shifting of the transmission.

9. The transmission position encoder as in claim 8, wherein the transmission controller is adapted to track the changes in bit pattern.

10. A bit map for a transmission position encoder having a plurality of sensors for a vehicle having a transmission, a transmission controller and a transmission shifter adapted to shift the transmission from any one of the following states of the transmission: park, reverse, neutral, drive, and any one of a plurality of gear positions comprising drive, the transmission shifter is also adapted to reposition the transmission position encoder, the bit map comprising:
a plurality of states corresponding to the position of the plurality of sensors of the transmission position encoder, wherein each of the plurality of states changes as the transmission is shifted from park to reverse and wherein at least two of said plurality of states are changed in any other shifting sequence of the transmission;
wherein said plurality of states are provided as signals to the transmission controller.

11. The bit map as in claim 10, wherein the plurality of states corresponding to the park position of the transmission are mixed.

12. The bit map as in claim 10, wherein the plurality of states are binary code comprising either a high output or a low output.

13. The bit map as in claim 10, wherein the plurality of sensors are hall sensors.

14. The bit map as in claim 10, wherein the transmission position encoder is adapted to sense either linear or angular movement.

15. The bit map as in claim 14, wherein the linear or angular movement of the transmission position encoder corresponds to shifting of the transmission.

16. The bit map as in claim 10, wherein the transmission controller is adapted to track and compare the changes in the bit pattern to a look up table in the memory of the transmission controller.

17. A transmission position encoder for a vehicle having a transmission, a transmission controller and a transmission shifter adapted to shift the transmission and reposition the transmission position encoder, the transmission position encoder comprising:
a plurality of detectors for providing a plurality of signals to the controller, said plurality of signals corresponding to discrete positions of the transmission position encoder wherein the controller is adapted to determine if there is a failure in any one of the detectors as the transmission position encoder transitions from a single position to one other position.

18. The transmission position encoder as in claim 17, wherein said plurality of detectors is three detectors.

19. The transmission position encoder as in claim 18, wherein each of said plurality of signals changes when the transmission is shifted from park to reverse and the plurality of signals are in a mixed state when the vehicle is started in park.

20. The transmission position encoder as in claim 18, wherein each of said plurality of signals changes when the transmission is shifted from neutral to drive.

21. The transmission position encoder as in claim 18, wherein each of said plurality of signals is powered up in a mixed state corresponding to the transmission being in park.

22. The transmission position encoder as in claim 19, wherein at least two of said plurality of signals changes with any shifting of the transmission.

23. The transmission position encoder as in claim 22, wherein the transmission controller is adapted to track the changes in plurality of signals.

24. The transmission position encoder as in claim 17, wherein said plurality of detectors is four detectors and a unique binary code is provided for each gear of the transmission and a transition position before and after each gear position.

25. The transmission position encoder as in claim 24, wherein each of said plurality of signals changes when the transmission is shifted from park to reverse and each of said plurality of signals is powered up in a mixed state corresponding to the transmission being in park.

26. The transmission position encoder as in claim 25, wherein the transmission controller is adapted to track the changes in plurality of signals.

27. An absolute position encoder and system for detection of discrete positions within a transmission of a vehicle, comprising:
a transmission controller and a transmission shifter adapted to shift the transmission and reposition a transmission position encoder; and
a means for providing a plurality of signals to the transmission controller, said plurality of signals corresponding to discrete positions of the transmission position encoder wherein the controller is adapted to determine if there is a failure in said means as the transmission position encoder transitions from a single position to one other position.
